(19) United States
(12) Patent Application Publication
(10) Pub. No.: US 2011/0279972 A1
(43) Pub. Date: Nov. 17, 2011

(54) COMPUTER ENCLOSURE WITH LOCKABLE BEZEL

(75) Inventor: YUAN XUE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/882,586

(22) Filed: Sep. 15, 2010

(30) Foreign Application Priority Data
May 11, 2010 (CN) 201010168802.5

(51) Int. Cl. G06F 1/16

(52) U.S. Cl. 361/679.57

(57) ABSTRACT

A computer enclosure includes a front panel, a bezel attached to a front side of the front panel, a locking module attached to the bezel, and a latch member attached to the front panel. An opening is defined in the front panel. The latch member partially extends through the opening of the front panel to engage with the locking module. The locking module is capable of rotating from a first position, where the locking module is engaged with the latch member to lock the bezel in place, to a second position, where the locking module is disengaged from the latch member to unlock the bezel.

### BACKGROUND

1. Technical Field

The present disclosure relates to computer enclosures, and more particularly to a computer enclosure having a lockable bezel.

2. Description of Related Art

Typical computer enclosures usually uses screws or plastic retainers to secure computer bezels on the enclosures. To install or remove the computer bezels, tools such as a screwdriver are required, which is inconvenient for consumers. Besides, the bezels of the typical computer enclosures can be detached by any unauthorized persons wielding a simple tool, exposing expensive components in the enclosures to easy theft.

### BRIEF DESCRIPTION OF THE DRAWINGS

FIG. 1 is an exploded view of a partly shown computer enclosure to which a bezel is to be attached according to an embodiment.

FIG. 2 is an assembled view of FIG. 1, showing the bezel in a locked state.

FIG. 3 is similar to FIG. 2, but viewed from another aspect.

FIG. 4 is an assembled view of FIG. 1, showing the bezel in an unlocked state.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean at least one.

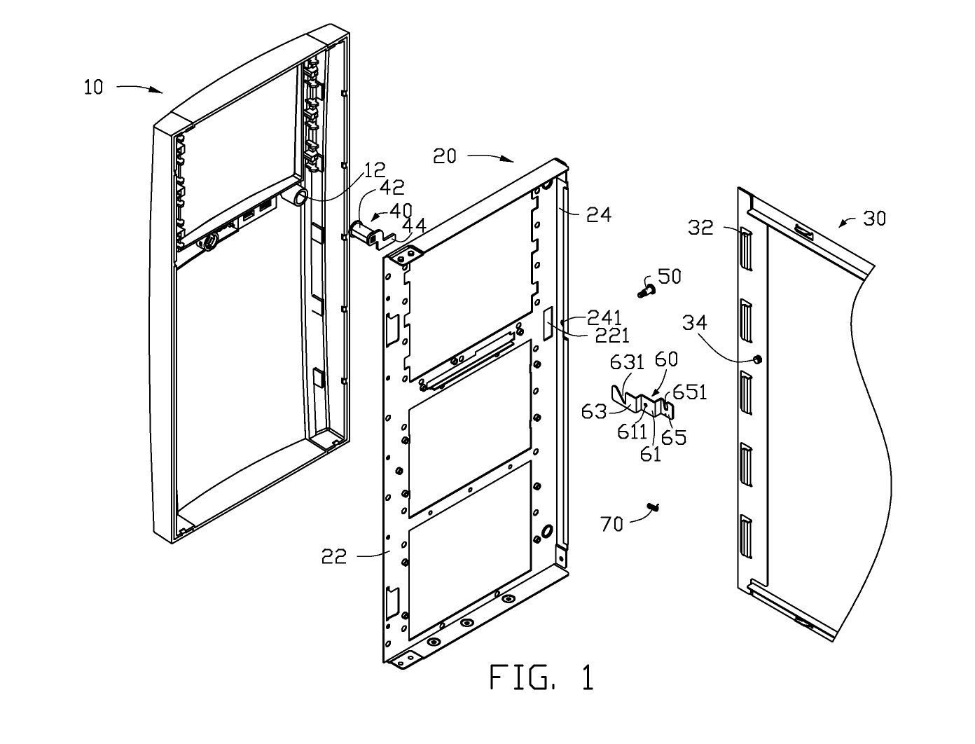

Referring to FIG. 1, an embodiment of a computer enclosure includes a bezel 10, a front panel 20, a side panel 30, a locking module 40, a bolt 50, a latch member 60, and a spring 70.

The locking module 40 includes a key socket 42 and a Z-shaped locking piece 44 secured at a distal end of the key socket 42. A cavity 12 is defined in the bezel 10 for mounting the key socket 42.

The front panel 20 includes a main body 22 and a flange 24 perpendicularly bent from a side edge of the main body 22. A mounting hole 241 is defined in the flange 24 for mounting the bolt 50. A opening 221 adjacent to the mounting hole 241 is defined in the main body 22.

The latch member 60 includes a central section 61, a first side section 63, and a second section 65. The first section 63 and the second section 65 are both L-shape and connected to opposite sides of the central section 61. A pivot hole 611 is defined in the central section 61. A first gap 631 is defined in the first section 63. A second gap 651 is defined in the second section 65.

The side panel 30 includes a plurality of clasps 32 for clasping the flange 24 of the front panel 20. A post 34 protrudes from an inner surface of the side panel 30 for engaging with the second gap 651 of the latch member 60.

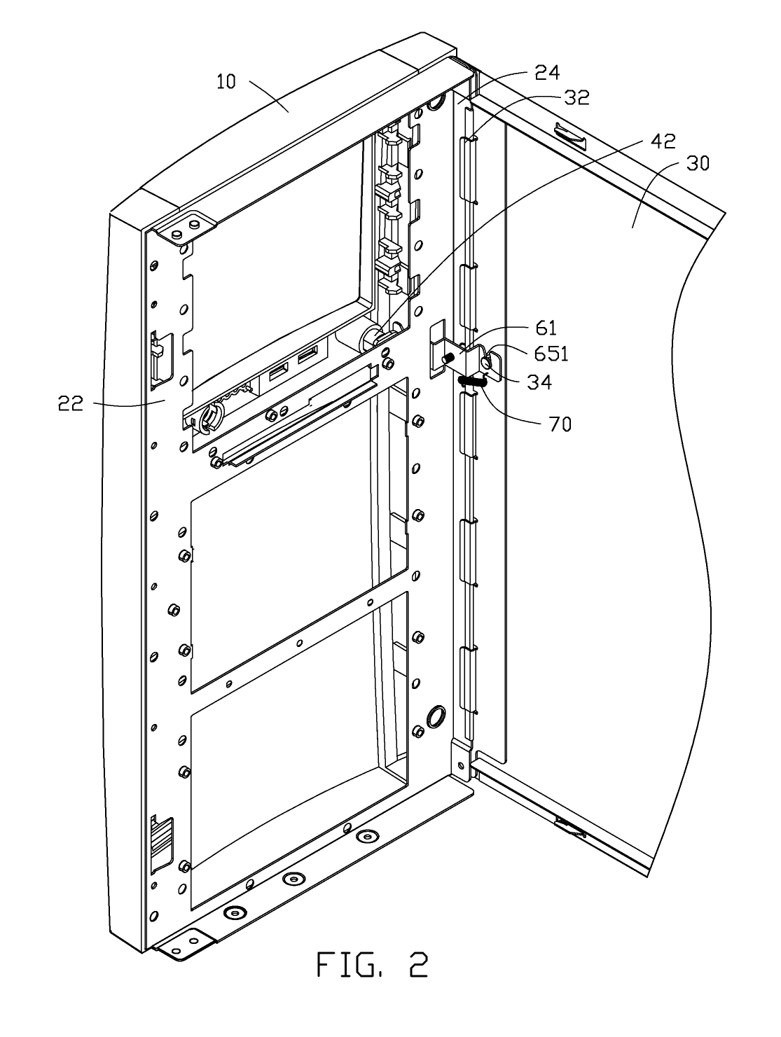

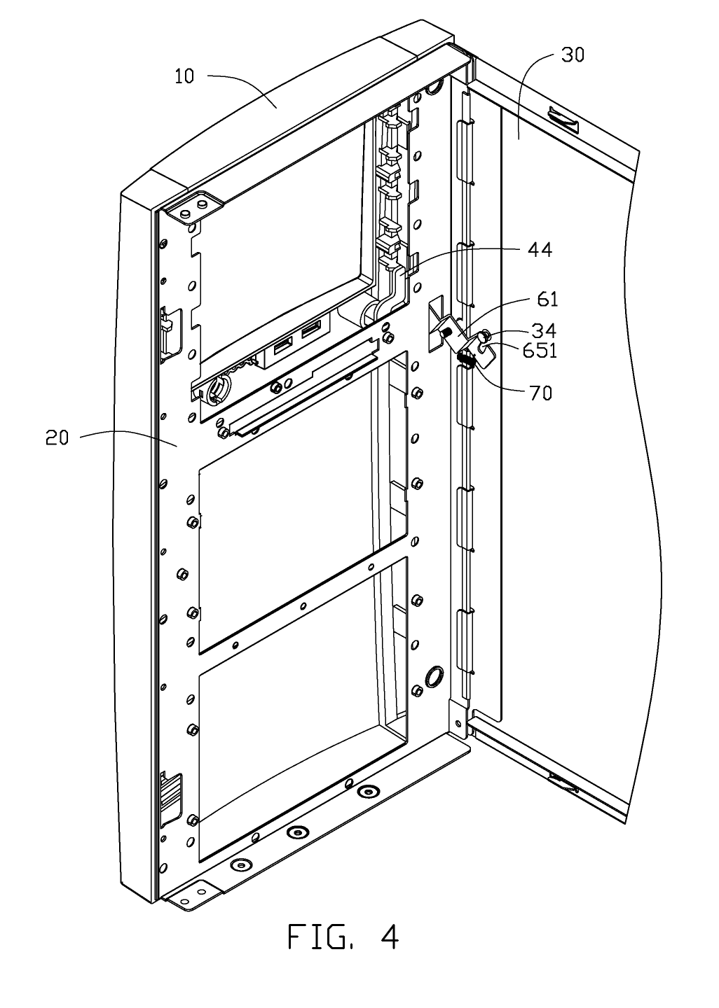

Referring to FIGS. 2-4, in assembly, the first side section 63 of the latch member 60 is inserted into the opening 221 of the front panel 20. The pivot hole 611 of the latch member 60 is aligned with the mounting hole 241 of the front panel 20. The bolt 50 is inserted into the mounting hole 241 of the front panel 20 and the pivot hole 611 of the latch member 60. Then the latch member 60 can be pivotably attached to the front panel 20. A length of the opening 221 is greater than a width of the latch member 60, thereby the latch member 60 is movable in the opening 221.

The flange 24 of the front panel 20 is held by the clasps 32 of the side panel 30. One end of the spring 70 is inserted in a small hole (not shown) defined in the flange 24 of the front panel 20. Another end of the spring 70 is engaged in another small hole defined in the second side section 65 of the latch member 60. The key socket 42 of the locking module 40 is mounted in the cavity 12 of the bezel 10. The bezel 10 is attached to a front side of the front panel 20. The locking piece 44 of the locking module 40 is engagable with the first gap 631 of the latch member 60.

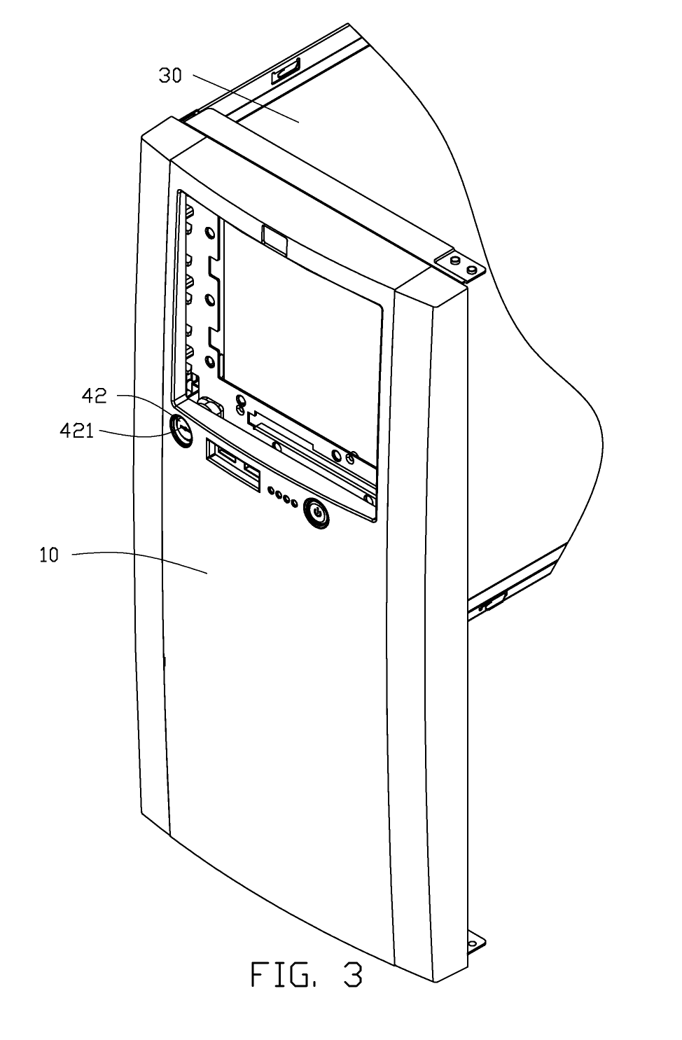

To lock the bezel 10 to the front panel 20, a key can be inserted in a keyhole 421 (see FIG. 3) of the key socket 42 to rotate the locking piece 44 to a locked position. At the locked position, the locking piece 44 is engaged in the first gap 631 of the latch member 60 and resists against a bottom of the latch member 60; the latch member 60 is rotated to a horizontal position perpendicular to the main body 22 of the front panel 20; the post 34 of the side panel 30 is engaged in the second gap 651 of the latch member 60 (See FIG. 2); and the spring 70 is stretched and resiliently deformed.

To detach the bezel 10 from the front panel 20, the key can be inserted in the keyhole 421 of the key socket 42 to rotate the locking piece 44 to an unlocked position. In the unlocked position, the locking piece 44 is disengaged from the first gap 631 and releases the latch member 60; the spring 70 urges the latch member 60 to rotate to a slanting position where the latch member 60 is disengaged from both of the locking piece 44 of the locking member 40 and the post 34 of the side panel 30.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A computer enclosure comprising:
a side panel;
a front panel attached to a front side of the side panel;
a bezel configured to cover the front panel;
a locking module attached to the bezel; and
a latch member comprising a central section pivotably mounted to the front panel, a first side section engagable with the locking module, and a second side section engagable with the side panel;
wherein the locking module can be actuated by a key to rotate from a first position, where the locking module is engaged with the latch member to lock the bezel, to a second position, where the locking module is disengaged from the latch member to unlock the bezel.

2. The computer enclosure of claim 1, wherein a cavity is defined in the bezel, the locking module comprises a key socket mounted in the cavity and a locking piece attached to the key socket, the locking piece is engaged with the first side section in the first position and disengaged from the first side section in the second position.

3. The computer enclosure of claim 2, wherein a keyhole is defined in the key socket, and the locking piece is located at a rear side of the bezel.

4. The computer enclosure of claim 1, wherein the front panel comprises a main body and a flange extending from the main body, a pivot hole is defined in the central section of the latch member, and a bolt is attached to the flange of the front panel and engaged in the pivot hole of the latch member.

5. The computer enclosure of claim 4, wherein a first gap is defined in the first side section, and the locking module is engaged with the first gap in the first position.

6. The computer enclosure of claim 5, wherein a second gap is defined in the second side section, a post protrudes from the side panel and is engaged in the second gap when the locking module is in the first position.

7. The computer enclosure of claim 6, further comprising a spring connected to the flange of the front panel and the second side section of the latch member.

8. The computer enclosure of claim 6, wherein the latch member is perpendicular to the main body of the front panel in the first position, and inclined relative to the main body of the front panel in the second position.

9. The computer enclosure of claim 1, wherein the first side section and the second side section are connected to opposite sides of the central section, and each of the first side section and the second side section are L-shaped.

10. A computer enclosure comprising:
a front panel with an opening defined therein;
a bezel attached to a front side of the front panel;
a locking module attached to the bezel; and
a latch member, attached to the front panel, partially extending through the opening of the front panel to engage the locking module;
wherein the locking module is capable of rotating from a first position, where the locking module is engaged with the latch member to lock the bezel, to a second position, where the locking module is disengaged from the latch member to unlock the bezel.

11. The computer enclosure of claim 10, wherein a cavity is defined in the bezel, the locking module comprises a key socket mounted in the cavity and a locking piece attached to a distal end of the key socket, and the locking piece is engaged with the latch member in the first position and disengaged from the latch member in the second position.

12. The computer enclosure of claim 11, wherein a keyhole is defined in the key socket, and the locking piece is located at a rear side of the bezel.

13. The computer enclosure of claim 10, further comprising a side panel attached to the front panel, the front panel comprises a main body and a flange extending from the main body, and the side panel comprises a plurality of clasps clasping the flange of the front panel.

14. The computer enclosure of claim 13, wherein a pivot hole is defined in the latch member, a mounting hole is defined in the flange of the front panel, and a bolt is inserted into the mounting hole and the pivot hole for pivotably attaching the latch member to the front panel.

15. The computer enclosure of claim 14, wherein the latch member includes a central section, a first side section, and a second side section; and the first side section and the second side section are connected to opposite sides of the central section, and the pivot hole is defined in the central section.

16. The computer enclosure of claim 15, wherein both of the first side section and the second side section are L-shaped.

17. The computer enclosure of claim 16, wherein a first gap is defined in the first side section, and the locking module is engaged with the first gap in the first position.

18. The computer enclosure of claim 17, wherein a second gap is defined in the second side section, and a post protrudes from the side panel and engages in the second gap when the locking module is in the first position.

19. The computer enclosure of claim 18, further comprising a spring located between the flange of the front panel and the second side section of the latch member.

20. The computer enclosure of claim 19, wherein the latch member is perpendicular to the main body of the front panel in the first position, and inclined relative to the main body of the front panel in the second position.
